(19) United States
(12) Patent Application Publication
(10) Pub. No.: US 2026/0015526 A1
(43) Pub. Date: Jan. 15, 2026

(54) THERMOPLASTIC ADHESIVE FILM

(71) Applicant: FAR EASTERN NEW CENTURY CORPORATION, Taipei City (TW)

(72) Inventors: Kun-Che HUNG, Taipei City (TW); Chun-Hsiung LIAO, Taipei City (TW)

(21) Appl. No.: 19/178,051

(22) Filed: Apr. 14, 2025

(30) Foreign Application Priority Data
Jul. 15, 2024 (TW) 113126453

(51) Int. Cl. C09J 7/35; C08J 11/24; C08J 11/26; C09J 7/25

(52) U.S. Cl. CPC C09J 7/35; C08J 11/24; C08J 11/26; C09J 7/255; C08J 2367/02; C09J 2301/304; C09J 2301/414

(57) ABSTRACT

A thermoplastic adhesive film includes a polyester layer having a moisture permeability of not greater than 5000 g/m²·24 h, and a hot melt adhesive layer disposed on the polyester layer and including a regenerated copolyester. The thermoplastic adhesive film is free from a urethane group. The regenerated copolyester is formed by subjecting a reactant composition containing a depolymerized component to a polymerization reaction. The depolymerized component is obtained by subjecting a recycled polyester to a depolymerization reaction in the presence of a depolymerizing agent. The depolymerizing agent is selected from the group consisting of a polyol component, a polycarboxylic acid component, and a combination thereof. The regenerated copolyester has a melting point ranging from 80° C. to 130° C., a glass transition temperature (Tg) ranging from −60° C. to 10° C., and an enthalpy ranging from 5 J/g to 30 J/g.

### CROSS-REFERENCE TO RELATED APPLICATION

This application claims priority to Taiwanese Invention patent application No. 113126453, filed on Jul. 15, 2024, the entire disclosure of which is incorporated by reference herein.

### FIELD

The present disclosure relates to a thermoplastic adhesive film.

### BACKGROUND

A thermoplastic adhesive film is often used to conform to waterproof requirement of daily necessities such as ski and snowboard jackets, shell jackets, waterproof casual jackets, hiking boots, waterproof casual shoes, medical protective clothing, tents, etc. The thermoplastic adhesive film can prevent water from seeping into an interior of the aforesaid daily necessities through junctions (e.g., seams or gaps) between elements (e.g., moisture-permeable waterproof membranes) thereof.

CN 101760163 A, CN 107163892 A, and CN 101434821 B each discloses a method for preparing a polyester hot melt adhesive with a water-resistant property using a poly(ethylene terephthalate) (PET) waste, which includes an alcoholysis reaction, an esterification step, and a polycondensation step. By conducting experiments on the methods of CN 101760163 A, CN 107163892 A, and CN 101434821 B, the inventors found that the polyester hot melt adhesive prepared by the method including the esterification step exhibited a relatively high enthalpy, resulting in the polyester hot melt adhesive being unable to securely adhere to a product, such as a fabric or footwear, originally adhered to the same after washing, and thus fails to meet consumer requirements.

TW 1499612 B discloses a method for preparing a copolyester ether film, which includes the following steps in sequence: subjecting a recycled aromatic polyester and a diol to an alcoholysis reaction so as to obtain a first intermediate product; subjecting the first intermediate product to a transesterification reaction so as to obtain a second intermediate product; subjecting the second intermediate product and a polyol to a polymerization reaction so as to obtain the copolyester ether, and transforming the copolyester ether into the copolyester ether film. The copolyester ether has an aromatic dicarboxylic acid ethylene glycol ester segment and an aromatic dicarboxylic acid butylene glycol ester segment. The copolyester ether has a melting point ranging from 150° C. to 200° C. and a glass transition temperature (Tg) ranging from −20° C. to −40° C. By conducting experiments on the method of TW 1499612 B, the inventors found that, since the melting point of the copolyester ether was too high, the copolyester ether film transformed from the copolyester ether, when serving as a hot melt adhesive, was unable to securely adhere to a product, such as a fabric or footwear, originally adhered to the same after washing, and thus fails to meet consumer requirements.

TW 1822243 B discloses a method for preparing a thermoplastic polyester elastomer (TPEE), which includes the following steps in sequence: subjecting a recycled poly(ethylene terephthalate) (PET) and a aliphatic diol to an alcoholysis reaction so as to form a bis(2-hydroxyethyl) terephthalate (BHET); and subjecting the BHET and a long chain poly(alkylene glycol) to a polymerization reaction so as to form the TPEE. By conducting experiments on the method of TW 1822243 B, the inventors found that the TPEE had a melting point not lower than 200° C., and since the melting point of the TPEE was too high, the TPEE, when serving as a hot melt adhesive, was unable to securely adhere to a product, such as a fabric or footwear, originally adhered to the same after washing, and thus fails to meet consumer requirements.

TW 1747380 B discloses a heat sealable polyester film made from a recycled polyester material. The heat sealable polyester film includes a base layer and a heat sealable layer. The heat sealable layer is formed from a first polyester composition which includes a physically regenerated polyester resin ranging from 50 wt % to 95 wt % and a chemically regenerated polyester resin ranging from 1 wt % to 40 wt %. The physically regenerated polyester resin is formed from a physically regenerated polyester masterbatch which includes a conventional physically regenerated polyester masterbatch and a modified physically regenerated polyester masterbatch. The modified physically regenerated polyester masterbatch includes regenerated poly(butylene terephthalate) (PBT) ranging from 0 wt % to 30 wt % and poly(ethylene terephthalate) (PET). The heat sealable layer of TW 1747380 B requires both the physically and chemically regenerated polyester resins, making composition thereof more complex. In addition, TW 1747380 B does not disclose that the heat sealable layer can be disposed on and applied to a moisture-permeable waterproof polyester membrane of a product such as a fabric or footwear. Therefore, TW 1747380 B does not disclose a washability of the product containing the moisture-permeable waterproof polyester membrane to which the heat sealable layer is adhered.

TW 202302729 A discloses a thermoplastic film composed of a single-layer hot melt adhesive film. The single-layer hot melt adhesive film has a melting point ranging from 50° C. to 160° C. and a Shore hardness ranging from 40 A to 80 A. A material of the single-layer hot melt adhesive film is a thermoplastic polyurethane with a urethane group. The thermoplastic film can be used to adhere to fabrics such as clothing, thereby reducing a need for stitching. However, a peel strength retention rate between the thermoplastic film and a fabric to which the thermoplastic film is adhered significantly drops to a value ranging from 63% to 76% after washing, and thus the fabric to which the thermoplastic film is adhered has a poor washability and fails to meet industry requirements. In addition, since most fabric materials used for the clothing are polyester, the use of the thermoplastic film containing the thermoplastic polyurethane with the urethane group may render recycling impossible due to material incompatibility. The thermoplastic film is also difficult to be removed from the clothing after heat bonding, and fails to achieve a sustainable environmental goal of waste reduction.

TW 1473716 B discloses a waterproof sealing tape which includes a waterproof polyester film and a polyester hot melt adhesive. However, TW 1473716 B does not disclose that the waterproof sealing tape can be disposed on and applied to a moisture-permeable waterproof polyester membrane of a product such as a fabric or footwear. Therefore, TW 1473716 B does not disclose a washability of the product containing the moisture-permeable waterproof polyester membrane to which the waterproof sealing tape is adhered. In addition, the polyester hot melt adhesive used in TW 1473716 B is not made from a recycled material (e.g., recycled poly(ethylene terephthalate) (PET)) and has a relatively regular structure. By conducting experiments on the method of TW 1473716 B, the inventors found that the product containing the moisture-permeable waterproof polyester membrane to which the polyester hot melt adhesive of the waterproof sealing tape is adhered cannot pass a washability test which includes the steps of subjecting the product to a washing treatment at a temperature of 45° C., followed by conducting a drying treatment at a temperature of 60° C. Furthermore, use of the polyester hot melt adhesive, which is not made from a recycled material, cannot achieve the goals of reducing waste and plastics.

In addition to the aforesaid TW 1473716 B, patent documents CN 87107206 A, CN 1015371 B, CN 110997318 A, CN 112585199 B, CN 115160939 B, TW 200403146 A, and JP 2007296798 A disclose a moisture-permeable waterproof bicomponent structure, a hot melt polyester film, a multilayer film, a moisture-permeable waterproof film, a hot melt adhesive laminate, a moisture-permeable waterproof and windproof laminated sheet, and a sealing tape (hereinafter collectively referred to as materials), respectively, each of which is not made from a recycled material (e.g., recycled PET). In addition, CN 87107206 A, CN 1015371 B, CN 110997318 A, CN 112585199 B, CN 115160939 B, TW 200403146 A, and JP 2007296798 A do not disclose that the aforesaid materials, respectively, can be disposed on and applied to a moisture-permeable waterproof polyester membrane of a product such as a fabric or footwear, and thus also do not disclose a washability of the product containing the moisture-permeable waterproof polyester membrane to which any of the aforesaid materials is adhered.

JP 3942367 B2 discloses a sealing tape and the method for preparing the same. The sealing tape is water washable and includes an adhesive layer and a base layer. Both the adhesive layer and the base layer are not made from a recycled material (e.g., recycled PET). The adhesive layer includes a polyether ester elastomer. The polyether ester elastomer is formed by subjecting an aromatic dicarboxylic acid ester and a polyether alcohol to a transesterification reaction and a polycondensation reaction in sequence, followed by dissolving in a solvent so as to form into a film, which raises a concern about solvent residue. Moreover, the polyether ester elastomer of JP 3942367 B2 has a relatively regular structure and a relatively high enthalpy, and thus requires relatively high temperature for effective bonding.

In view of the aforesaid, there is still an intention to develop a thermoplastic adhesive film which is made from a recycled material and is free from a urethane group.

### SUMMARY

Therefore, an object of the present disclosure is to provide a thermoplastic adhesive film, which can alleviate at least one of the drawbacks of the prior art.

According to the present disclosure, the thermoplastic adhesive film includes a polyester layer having a moisture permeability of not greater than 5000 g/m²·24 h, and a hot melt adhesive layer disposed on the polyester layer and including a regenerated copolyester. The thermoplastic adhesive film is free from a urethane group. The regenerated copolyester is formed by subjecting a reactant composition containing a depolymerized component to a polymerization reaction. The depolymerized component is selected from the group consisting of a depolymer with a main chain containing a terephthalic acid ester group, a depolymer with a main chain containing a terephthalic acid ester group and an isophthalic acid ester group, a depolymer with a main chain containing a terephthalic acid ester group and a bivalent C₁-C₄ straight chain dicarboxyl ester group, a depolymer with a main chain containing a terephthalic acid ester group, an isophthalic acid ester group, and a bivalent C₁-C₄ straight chain dicarboxyl ester group, a depolymer with a main chain containing an isophthalic acid ester group, a depolymer with a main chain containing a bivalent C₁-C₄ straight chain dicarboxyl ester group, a depolymer with a main chain containing an isophthalic acid ester group and a bivalent C₁-C₄ straight chain dicarboxyl ester group, and combinations thereof. The depolymerized component is obtained by subjecting a recycled polyester to a depolymerization reaction in the presence of a depolymerizing agent. The depolymerizing agent is selected from the group consisting of a polyol component, a polycarboxylic acid component, and a combination thereof. The recycled polyester is selected from the group consisting of a recycled polyester with a main chain containing a terephthalic acid ester group, a recycled polyester with a main chain containing a terephthalic acid ester group and an isophthalic acid ester group, and a recycled polyester with a main chain containing a terephthalic acid ester group and a bivalent C₁-C₄ straight chain dicarboxyl ester group. The regenerated copolyester has terephthalic acid derived from the recycled polyester in an amount of not lower than 20 wt %. The regenerated copolyester has a melting point ranging from 80° C. to 130° C., a glass transition temperature (Tg) ranging from −60° C. to 10° C., and an enthalpy ranging from 5 J/g to 30 J/g. The regenerated copolyester includes a first carboxylic acid ester segment present in an amount ranging from 50 mol % to 100 mol % and represented by formula (I), a second carboxylic acid ester segment present in an amount ranging from 0 mol % to 35 mol % and represented by formula (II), and a third carboxylic acid ester segment present in an amount ranging from 0 mol % to 15 mol % and represented by formula (III), based on a total amount of the regenerated copolyester as 100 mol %,

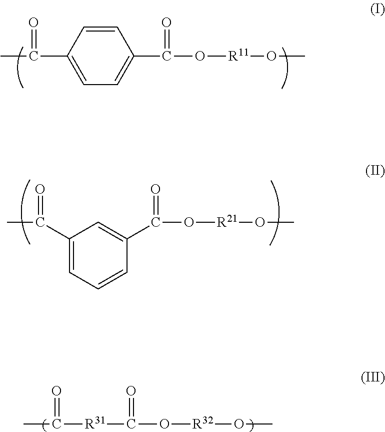

where
in formula (I), R¹¹ is a bivalent C₂-C₆ alkyl group or an alkyl ether group with a number average molecular weight ranging from 450 g/mol to 1000 g/mol,
in formula (II), R²¹ is a bivalent C₂-C₆ alkyl group or an alkyl ether group with a number average molecular weight ranging from 450 g/mol to 1000 g/mol, and,
in formula (III), R³¹ is a bivalent C₁-C₄ straight chain alkyl group, and R³² is a bivalent C₂-C₆ alkyl group or an alkyl ether group with a number average molecular weight ranging from 450 g/mol to 1000 g/mol.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### <Thermoplastic Adhesive Film>

The present disclosure provides a thermoplastic adhesive film which includes a polyester layer having a moisture permeability of not greater than 5000 g/m²·24 h, and a hot melt adhesive layer disposed on the polyester layer and including a regenerated copolyester. The thermoplastic adhesive film is free from a urethane group. The regenerated copolyester is formed by subjecting a reactant composition containing a depolymerized component to a polymerization reaction.

In certain embodiments, the polyester layer contains a polyether ester elastomer. Examples of the polyester layer that contains the polyether ester elastomer may include, but are not limited to, a commercially available moisture-permeable waterproof polyester membrane selected from the group consisting of TOPGREEN® TE1351SR (moisture permeability: 1061 g/m²·24 h, melting point: 174° C., resistance to hydrostatic pressure: 13000 mmH₂O), TOPGREEN® TE1331SR (moisture permeability: 1550 g/m²·24 h, melting point: 172° C., resistance to hydrostatic pressure: 13000 mmH₂O), TOPGREEN® TE1223R, (moisture permeability: 1649 g/m²·24 h, melting point: 186° C., resistance to hydrostatic pressure: 13000 mmH₂O), and TOPGREEN® TE1142SR (moisture permeability: 4624 g/m²·24 h, melting point: 163° C., resistance to hydrostatic pressure: 13000 mmH₂O), which are available from Far Eastern New Century Corporation. In certain embodiments, the moisture permeability of the polyester layer is not greater than 1600 g/m²·24 h.

According to the present disclosure, the regenerated copolyester has a melting point ranging from 80° C. to 130° C., a glass transition temperature (Tg) ranging from −60° C. to 10° C., and an enthalpy ranging from 5 J/g to 30 J/g. In certain embodiments, the regenerated copolyester has a melting point ranging from 85° C. to 125° C., a glass transition temperature (Tg) ranging from −60° C. to 7° C., and an enthalpy ranging from 12 J/g to 30 J/g.

It should be noted that, if the melting point of the regenerated copolyester is greater than 130° C., the thermoplastic adhesive film requires a relatively high temperature for bonding to a polyester element (e.g., a moisture-permeable waterproof polyester membrane) of a product (such as a fabric or footwear), which may cause the polyester element to crack, leading to a water leakage issue. If the melting point of the regenerated copolyester is lower than 80° C., the regenerated copolyester becomes difficult to cool down during a granulation process, causing the regenerated copolyester to wrap around a cutter, resulting in inconsistent pellet quality and adversely affecting subsequent processing.

In addition, if the glass transition temperature (Tg) of the regenerated copolyester is greater than 10° C., a molecular chain of the regenerated copolyester may have limited mobility, and thus when the thermoplastic adhesive film is heated and bonded to a polyester element (e.g., a moisture-permeable waterproof polyester membrane), the hot melt adhesive layer of the thermoplastic adhesive film cannot adhere well to the polyester element. If the glass transition temperature (Tg) of the regenerated copolyester is lower than −60° C., the hot melt adhesive layer of the thermoplastic adhesive film may easily swell when the thermoplastic adhesive film bonded to a polyester element is exposed to water, causing the thermoplastic adhesive film to be separated from the polyester element.

Moreover, if the enthalpy of the regenerated copolyester is greater than 30 J/g, the regenerated copolyester may have excessively high crystallinity, which makes the regenerated copolyester difficult to undergo a thermal treatment. Even with increased temperatures, there is a risk of a polyester element (e.g., a moisture-permeable waterproof polyester membrane) cracking during a thermal bonding process (including heat and melt bonding). If the enthalpy of the regenerated copolyester is lower than 5 J/g, the regenerated copolyester may have insufficient crystallinity, which allows water to easily infiltrate the molecular chain of the regenerated copolyester during a washing treatment, causing the thermoplastic adhesive film to swell and hence be separated from the polyester element.

The melting point, glass transition temperature (Tg), and enthalpy of the regenerated copolyester can be optimized by adjusting a type and a proportion of the reactant composition, and controlling operating temperature and time period for conducting the polymerization reaction and/or the depolymerization reaction.

According to the present disclosure, the regenerated copolyester includes a first carboxylic acid ester segment that is present in an amount ranging from 50 mol % to 100 mol % and represented by formula (I), a second carboxylic acid ester segment that is present in an amount ranging from 0 mol % to 35 mol % and represented by formula (II), and a third carboxylic acid ester segment that is present in an amount ranging from 0 mol % to 15 mol % and represented by formula (III), based on a total amount of the regenerated copolyester as 100 mol %,

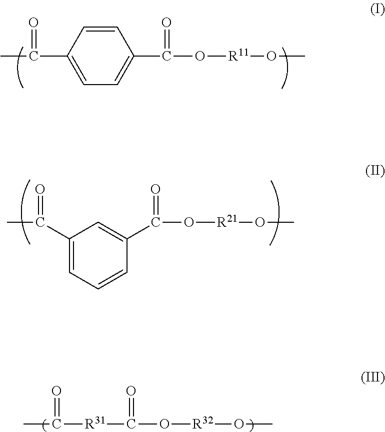

where
in formula (I), R¹¹ is a bivalent C₂-C₆ alkyl group or an alkyl ether group with a number average molecular weight ranging from 450 g/mol to 1000 g/mol,
in formula (II), R²¹ is a bivalent C₂-C₆ alkyl group or an alkyl ether group with a number average molecular weight ranging from 450 g/mol to 1000 g/mol, and
in formula (III), R³¹ is a bivalent C₁-C₄ straight chain alkyl group, and R³² is a bivalent C₂-C₆ alkyl group or an alkyl ether group with a number average molecular weight ranging from 450 g/mol to 1000 g/mol.

In certain embodiments, examples of the bivalent C₂-C₆ alkyl group in formulae (I), (II), and (III) may include, but are not limited to, a bivalent C₂-C₆ straight chain alkyl group and a bivalent C₂-C₆ branched chain alkyl group. Examples of the bivalent C₂-C₆ straight chain alkyl group may include, but are not limited to, a bivalent straight chain ethyl group (—CH₂—CH₂—), a bivalent straight chain propyl group (—CH₂—CH₂—CH₂—), a bivalent straight chain butyl group (—CH₂—CH₂—CH₂—CH₂—), a bivalent straight chain pentyl group (—CH₂—CH₂—CH₂—CH₂—CH₂—), and a bivalent straight chain hexyl group (—CH₂—CH₂—CH₂—CH₂—CH₂—CH₂—). Examples of the bivalent C₂-C₆ branched chain alkyl group may include, but are not limited to, —CH₂—CH₂—CH(CH₃)—CH₂—CH₂— and —CH₂—C(CH₃) 2—CH₂—. Examples of the bivalent C₁-C₄ straight chain alkyl group in formula (III) may include, but are not limited to, a bivalent straight chain methyl group (—CH₂—), a bivalent straight chain ethyl group (—CH₂—CH₂—), a bivalent straight chain propyl group (—CH₂—CH₂—CH₂—), and a bivalent straight chain butyl group (—CH₂—CH₂—CH₂—CH₂—).

In certain embodiments, an example of the alkyl ether group in formulae (I), (II), and (III) may include, but is not limited to, —(X) n-O—, in which X represents a bivalent alkyl group and n is an integer not lower than 2. In certain embodiments, the alkyl ether group in formula (I) has a number average molecular weight ranging from 960 g/mol to 1000 g/mol. In certain embodiments, the alkyl ether group in formula (II) has a number average molecular weight ranging from 960 g/mol to 1000 g/mol. In certain embodiments, the alkyl ether group in formula (III) has a number average molecular weight ranging from 960 g/mol to 1000 g/mol.

In certain embodiments, in the regenerated copolyester, the first carboxylic acid ester segment represented by formula (I), the second carboxylic acid ester segment represented by formula (II), and the third carboxylic acid ester segment represented by formula (III) are arranged in a random manner.

According to the present disclosure, the depolymerized component is selected from the group consisting of a depolymer with a main chain containing a terephthalic acid ester group, a depolymer with a main chain containing a terephthalic acid ester group and an isophthalic acid ester group, a depolymer with a main chain containing a terephthalic acid ester group and a bivalent C₁-C₄ straight chain dicarboxyl ester group, a depolymer with a main chain containing a terephthalic acid ester group, an isophthalic acid ester group, and a bivalent C₁-C₄ straight chain dicarboxyl ester group, a depolymer with a main chain containing an isophthalic acid ester group, a depolymer with a main chain containing a bivalent C₁-C₄ straight chain dicarboxyl ester group, a depolymer with a main chain containing an isophthalic acid ester group and a bivalent C₁-C₄ straight chain dicarboxyl ester group, and combinations thereof.

According to the present disclosure, the depolymerized component is obtained by subjecting a recycled polyester to a depolymerization reaction in the presence of a depolymerizing agent. The depolymerizing agent is selected from the group consisting of a polyol component, a polycarboxylic acid component, and a combination thereof. The recycled polyester is selected from the group consisting of a recycled polyester with a main chain containing a terephthalic acid ester group, a recycled polyester with a main chain containing a terephthalic acid ester group and an isophthalic acid ester group, and a recycled polyester with a main chain containing a terephthalic acid ester group and a bivalent C₁-C₄ straight chain dicarboxyl ester group.

In certain embodiments, the depolymerizing agent further includes a benzenedicarboxylic acid dialkyl ester. Examples of the benzenedicarboxylic acid dialkyl ester may include, but are not limited to, dimethyl terephthalate (DMT) and dimethyl isophthalate (DMI).

In certain embodiments, the depolymerizing agent is the polycarboxylic acid component, and the polycarboxylic acid component is present in an amount ranging from 0 mol % to 10 mol %, based on a total amount of the polycarboxylic acid component and the recycled polyester as 100 mol %. In certain embodiments, in order to provide the regenerated copolyester with appropriate elasticity, the polycarboxylic acid component includes a C₆-C₁₂ straight chain dicarboxylic acid. Examples of the C₆-C₁₂ straight chain dicarboxylic acid may include, but are not limited to, adipic acid, heptanedioic acid, octandioic acid, azelaic acid, and sebacic acid.

In certain embodiments, the depolymerizing agent is the polyol component, and the polyol component includes at least two polyols selected from the group consisting of a C₂-C₆ diol and a polyether polyol with a number average molecular weight ranging from 450 g/mol to 1000 g/mol. In certain embodiments, the polyol component includes at least two polyols selected from the group consisting of a C₂-C₆ diol and a polyether polyol with a number average molecular weight ranging from 960 g/mol to 1000 g/mol. In certain embodiments, in the polyol component, one of the at least two polyols is hexylene glycol.

In certain embodiments, the polyol component is a biomass polyol component. The biomass polyol component can be made from a biological organism (e.g., plants such as corns). In certain embodiments, the polyol component may be formed by subjecting a waste gas (e.g., carbon dioxide) to a conversion process.

In certain embodiments, the C₂-C₆ diol in the polyol component is selected from the group consisting of ethylene glycol, propylene glycol, butylene glycol, pentylene glycol, 3-methyl-1,5-pentanediol, hexylene glycol, neopentyl glycol, and combinations thereof.

In certain embodiments, the polyether polyol in the polyol component has a weight average molecular weight (Mw) ranging from 500 g/mol to 4000 g/mol. In certain embodiments, the polyether polyol in the polyol component is selected from the group consisting of a copolymer of ethylene oxide and propylene epoxide, a copolymer of ethylene oxide and tetrahydrofuran, poly(ethylene glycol) (PEG), poly(propylene glycol), poly(trimethylene ether)glycol (PO3G), poly(hexylene glycol), poly(tetramethylene ether)glycol (PTMEG), decaethylene glycol, and combinations thereof. An example of the copolymer of ethylene oxide and tetrahydrofuran may include, but is not limited to, a commercially available copolymer (manufacturer: Oriental Union Chemical Corporation, model no.: CT183) with a weight average molecular weight (Mw) ranging from 1000 g/mol to 3000 g/mol.

In certain embodiments, examples of the recycled polyester may include, but are not limited to, a waste polymer material, a discarded poly(ethylene terephthalate) (PET) bottle, a waste fabric, and an abandoned fishing net.

According to the present disclosure, since the regenerated copolyester is prepared by utilizing the recycled polyester, the thermoplastic adhesive film provides the recycled polyester with a reuse value, thereby reducing environmental pollution.

In certain embodiments, the reactant composition further includes a polyether polyol with a number average molecular weight ranging from 450 g/mol to 1000 g/mol. In certain embodiments, the polyether polyol in the reactant composition has a number average molecular weight ranging from 960 g/mol to 1000 g/mol. The detail of the polyether polyol in the reactant composition is generally the same as that of the polyether polyol in the polyol component as described in the foregoing, and is not repeated herein for the sake of brevity.

In certain embodiments, the polyol component includes the at least two polyols which are C₂-C₆ diols, and the reactant composition further includes the polyether polyol. The polyether polyol in the reactant composition is present in an amount ranging from 15 wt % to 23 wt %, based on the total weight of the polyol component and the reactant composition.

According to the present disclosure, the regenerated copolyester has terephthalic acid derived from the recycled polyester in an amount of not lower than 20 wt % of. In certain embodiments, the regenerated copolyester has terephthalic acid ranging from 50 wt % to 80 wt % and derived from the recycled polyester.

### <Composite Laminated Body>

The present disclosure also provides a composite laminated body which includes the aforesaid thermoplastic adhesive film and a polyester element which is free from a urethane group. Since each of the thermoplastic adhesive film and the polyester element is free from a urethane group, the composite laminated body is free from a urethane group. The polyester element has a moisture permeability of not greater than 5000 g/m²·24 h and is disposed on a surface of the hot melt adhesive layer opposite to the polyester layer of the thermoplastic adhesive film.

According to the present disclosure, the composite laminated body has a resistance to hydrostatic pressure ranging from 4000 mmH₂O to 8000 mmH₂O which is determined according to the hydrostatic pressure test set forth in JIS L1092.

According to the present disclosure, in the composite laminated body, a peel strength retention rate between the hot melt adhesive layer and the polyester element is not lower than 80%. In certain embodiments, the peel strength retention rate between the hot melt adhesive layer and the polyester element is not lower than 85%. In certain embodiments, the peel strength retention rate between the hot melt adhesive layer and the polyester element is not lower than 90%.

In certain embodiments, the polyester element contains a thermoplastic elastomer such as a polyether ester elastomer. Examples of the polyester element that contains the polyether ester elastomer may include, but are not limited to, a commercially available moisture-permeable waterproof polyester membrane selected from the group consisting of TOPGREEN® TE1351SR (moisture permeability: 1061 g/m²·24 h, melting point: 174° C., resistance to hydrostatic pressure: 13000 mmH₂O), TOPGREEN® TE1331SR (moisture permeability: 1550 g/m²·24 h, melting point: 172° C., resistance to hydrostatic pressure: 13000 mmH₂O), TOPGREEN® TE1223R (moisture permeability: 1649 g/m²·24 h, melting point: 186° C., resistance to hydrostatic pressure: 13000 mmH₂Or), and TOPGREEN® TE1142SR (moisture permeability: 4624 g/m²·24 h, melting point: 163° C., resistance to hydrostatic pressure: 13000 mmH₂O), which are available from Far Eastern New Century Corporation.

In certain embodiments, the composite laminated body further includes a polyester textile layer which is disposed on a surface of the polyester layer opposite to the hot melt adhesive layer of the thermoplastic adhesive film. In certain embodiments, the composite laminated body further includes a polyester textile layer which is disposed on a surface of the polyester element opposite to the thermoplastic adhesive film. In certain embodiments, the polyester textile layer may be a part of clothing or footwear, such as a fabric element in clothing or an upper material in shoes.

According to the present disclosure, the composite laminated body may be prepared by subjecting the thermoplastic adhesive film to a heating treatment so that the hot melt adhesive layer is in a molten state, followed by bonding the hot melt adhesive layer to the polyester element. Examples of the heating treatment may include, but are not limited to, a hot-press sealing treatment, a hot-air rolling treatment, a microwave treatment, and a high-frequency treatment.

According to the present disclosure, the polyester element may be a fabric element in clothing or an upper material in footwear, and may be subjected to the aforesaid heating treatment to be bonded to the surface of the hot melt adhesive layer opposite to the polyester layer, thereby forming the composite laminated body. Hence, the composite laminated body thus formed may become a part of clothing or footwear.

According to the present disclosure, by virtue of optimizing the melting point, glass transition temperature (Tg), and enthalpy of the regenerated copolyester, the thermoplastic adhesive film containing the polyester layer and the hot melt adhesive layer that includes the regenerated copolyester can be effectively applied to seam junctions between elements (e.g., moisture-permeable waterproof membranes or polyester elements) in products such as fabrics or footwear, thereby allowing the products to have excellent washability, maintaining a strong adhesive property of the thermoplastic adhesive film after undergoing a washing treatment and a drying treatment, and maintaining a waterproof functionality at the seam junctions in the products. In addition, by virtue of an essential material of the thermoplastic adhesive film being a polyester, the thermoplastic adhesive film being free from the urethane group, as well as the regenerated copolyester being prepared by utilizing the recycled polyester, the thermoplastic adhesive film can achieve sustainable environmental goals of waste reduction and plastics reduction.

The disclosure will be further described by way of the following examples. However, it should be understood that the following examples are solely intended for the purpose of illustration and should not be construed as limiting the disclosure in practice.

### EXAMPLES

### Example 1 (EX1)

First, 192 g (i.e., 1 mole) of poly(ethylene terephthalate) (PET)-based recycled resin particles (serving as a recycled polyester, manufacturer: Far Eastern New Century Corporation), 89 g (i.e., 0.99 mole) of 1,4-butanediol (serving as a C₂-C₆ diol of a depolymerizing agent), 24 g (i.e., 0.2 mole) of 1,6-hexanediol (serving as a C₂-C₆ diol of a depolymerizing agent), and 0.37 g of titanium tetraisopropanolate (TPT, serving as a depolymerization catalyst) were subjected to a depolymerization reaction at a temperature of 240° C. until no residual PET-based recycled resin particles remained, indicating that the PET-based recycled resin particles were completely depolymerized, so as to obtain a depolymerized component with a main chain containing a terephthalate group and an isophthalate group.

To be specific, the PET-based recycled resin particles had a main chain containing an ethylene terephthalate segment and an ethylene isophthalate segment. The ethylene isophthalate segment was present in an amount of 3 mol %, based on a total amount of the PET-based recycled resin particles as 100 mol %. The PET-based recycled resin particles were prepared by subjecting a raw material containing a recycled PET bottle, a waste fabric, and an abandoned clothing to a sorting process, a crushing process, a cleaning process, a decomposition process, a polymerization process, a viscosity enhancing process, and a granulation process in sequence.

Next, the depolymerized component, 74 g (i.e., 0.074 mole) of poly(ethylene glycol) (PEG, serving as a polyether polyol of a reactant composition, weight average molecular weight (Mw): 1000 g/mol), 0.63 g of TPT (serving as a polymerization catalyst), 0.32 g of N,N′-(hexane-1,6-diyl)bis(3—(3,5-di-tert-butyl-4-hydroxyphenyl) propanamide) (serving as an antioxidant, manufacturer: BASF, model no.: Irganox®1098, hereafter abbreviated as Irganox®1098), and 0.48 g of 3,9-bis(2,4-dicumylphenoxy)-2,4,8,10-tetra-oxa-3,9-diphosphaspiro[5.5]undecane (serving as an antioxidant, model no.: Revonox@608, hereafter abbreviated as Revonox®608) were subjected to a polymerization reaction at a temperature of 250° C. and a pressure of 1 torr for a time period of 4 hours, so as to obtain a regenerated copolyester of EX1.

Thereafter, the regenerated copolyester was placed between two release papers, followed by conducting a hot pressing treatment at a temperature of 200° C. and a pressure of 50 kgf, so as to obtain a hot melt adhesive layer of EX1 with a thickness of 50 μm. Subsequently, the hot melt adhesive layer of EX1 was disposed on a surface of a polyester layer with a thickness of 50 μm (manufacturer: Far Eastern New Century Corporation, model no.: TOPGREEN® TE1331SR, ingredient: a polyether ester elastomer), followed by conducting a hot pressing treatment using a hot press machine at a temperature of 140° C. and a pressure of 2 kgf to allow the surface of the polyester layer to be bonded to the hot melt adhesive layer of EX1, so as to obtain a thermoplastic adhesive film of EX1 which included the polyester layer and the hot melt adhesive layer of EX1.

Afterwards, a polyester element was disposed on a surface of the hot melt adhesive layer of EX1 opposite to the polyester layer of the thermoplastic adhesive film of EX1, followed by conducting a hot pressing treatment using a hot press machine at a temperature of 150° C. and a pressure of 2 kgf, so as to obtain a composite laminated body of EX1. To be specific, the polyester element was free from a urethane group and was a commercially available moisture-permeable waterproof polyester membrane selected from the group consisting of TOPGREEN® TE1331SR (thickness: 50 μm, hereafter abbreviated as TE1331SR), TOPGREEN® TE1223R (thickness: 20 μm, hereafter abbreviated as TE1223R), and TOPGREEN® TE1142SR (thickness: 40 μm, hereafter abbreviated as TE1142SR), which were available from Far Eastern New Century Corporation.

### Comparative Example 1 (CE1)

First, 188 g (i.e., 0.97 mole) of dimethyl terephthalate (DMT), 4 g (i.e., 0.03 mole) of dimethyl isophthalate (DMI), 89 g (i.e., 0.99 mole) of 1,4-butanediol (serving as a C₂-C₆ diol), 24 g (i.e., 0.2 mole) of 1,6-hexanediol (serving as a C₂-C₆ diol), and 0.37 g of TPT (serving as an esterification catalyst) were mixed and then were subjected to an esterification reaction at a temperature of 240° C. for a time period of 4 hours until no methanol was distilled out, so as to obtain an esterified mixture.

Next, the esterified mixture, 74 g of (i.e., 0.074 mole) of PEG (weight average molecular weight (Mw): 1000 g/mol, serving as a polyether polyol), 0.63 g of TPT (serving as a polymerization catalyst), 0.32 g of the Irganox®1098 (serving as an antioxidant) and 0.48 g of the Revonox@608 (serving as an antioxidant) were subjected to a polymerization reaction at a temperature of 250° C. and a pressure of 1 torr for a time period of 4 hours, so as to obtain a copolyester of CE1.

The subsequent procedures and materials for preparing the thermoplastic adhesive film and the composite laminated body of CE1 were similar to those of EX1, except that in CE1, the regenerated copolyester of EX1 was substituted by the copolyester of CE1.

### Examples 2 to 7 (EX2 to EX7) and Comparative Examples 2, 3, and 6 (CE2, CE3, and CE6)

The procedures for preparing the thermoplastic adhesive films and the composite laminated bodies of EX2 to EX7, CE2, CE3, and CE6 were similar to those of EX1, except that the type of materials and the amounts thereof were varied as shown in Tables 1 to 4. To be specific, in EX3 and EX4,1,3-propanediol and poly(trimethylene ether)glycol (PO3G) were made from a biomass material (e.g., corns) and were biomass monomers. Since the PET-based recycled resin particles of EX6 (manufacturer: Far Eastern New Century Corporation) had a main chain containing an ethylene terephthalate segment but free from an ethylene isophthalate segment, the ethylene isophthalate segment was present in an amount of 0 mol %, based on a total amount of the PET-based recycled resin particles of EX6 as 100 mol %.

### Comparative Example 4 (CE4)

First, 15 g (i.e., 0.1 mole) of adipic acid, 45 g (i.e., 0.72 mole) of ethylene glycol (serving as a C₂-C₆ diol), 50 g (i.e., 0.42 mole) of 1,6-hexanediol (serving as a C₂-C₆ diol), 6 g (i.e., 0.06 mole) of neopentyl glycol (serving as a C₂-C₆ diol), and 0.27 g of TPT (serving as an esterification catalyst) were mixed and then subjected to an esterification reaction at a temperature of 240° C. for a time period of 1 hour until no water was distilled out, so as to obtain an esterified mixture.

Next, the esterified mixture and 173 g (i.e., 0.9 mole) of the PET-based recycled resin particles (serving as a recycled polyester, same as the PET-based recycled resin particles of EX1) were subjected to a depolymerization reaction at a temperature of 240° C. for a time period of 4 hours until no more PET-based recycled resin particles remained, indicating that the PET-based recycled resin particles were completely depolymerized, so as to obtain a depolymerized component with a main chain containing a terephthalate group and an isophthalate group.

Thereafter, the depolymerized component, 0.46 g of TPT (serving as a polymerization catalyst), 0.23 g of the Irganox®1098 (serving as an antioxidant), and 0.35 g of the Revonox®608 (serving as an antioxidant) were subjected to a polymerization reaction at a temperature of 250° C. and a pressure of 1 torr for a time period of 4 hours, so as to obtain a regenerated copolyester of CE4.

The subsequent procedures and materials for preparing the thermoplastic adhesive film and the composite laminated body of CE4 were similar to those of EX1, except that in CE4, the regenerated copolyester of EX1 was substituted by the regenerated copolyester of CE4.

### Comparative Example 5 (CE5)

First, 173 g (i.e., 0.9 mole) of the PET-based recycled resin particles (serving as a recycled polyester, same as the PET-based recycled resin particles of EX1), 45 g (i.e., 0.72 mole) of ethylene glycol (serving as a C₂-C₆ diol), 50 g (i.e., 0.42 mole) of 1,6-hexanediol (serving as a C₂-C₆ diol), 6 g (i.e., 0.06 mole) of neopentyl glycol (serving as a C₂-C₆ diol), and 0.27 g of TPT (serving as a depolymerization catalyst) were mixed and then subjected to a depolymerization reaction at a temperature of 240° C. for a time period of 4 hours until no PET-based recycled resin particles remained, indicating that the PET-based recycled resin particles were completely depolymerized, so as to obtain a depolymerized component with a main chain containing a terephthalate group and an isophthalate group.

Next, the depolymerized component and 15 g (i.e., 0.1 mole) of adipic acid were subjected to an esterification reaction at a temperature of 240° C. for a time period of 1 hour until no water was distilled out, so as to obtain an esterified mixture.

Thereafter, the esterified mixture, 0.46 g of TPT (serving as a polymerization catalyst), 0.23 g of the Irganox®1098 (serving as an antioxidant), and 0.35 g the Revonox®608 (serving as an antioxidant) were subjected to a polymerization reaction at a temperature of 250° C. and a pressure of 1 torr for a time period of 4 hours, so as to obtain a regenerated copolyester of CE5.

The subsequent procedures and materials for preparing the thermoplastic adhesive film and the composite laminated body of CE5 were similar to those of EX1, except that in CE5, the regenerated copolyester of EX1 was substituted by the regenerated copolyester of CE5.

The materials, the amounts thereof, and the operating conditions for preparing the thermoplastic adhesive films and the composite laminated bodies of EX1 to EX7 and CE1 to CE6 are summarized in Tables 1 to 4 below.

To be specific, the amount (unit: wt %) of the polyether polyol in the C₂-C₆ diol and the polyether polyol shown in Tables 1 to 4 below was calculated using the following Equation (1):

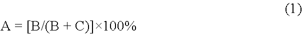

where A=amount of polyether polyol in C₂-C₆ diol and polyether polyol (wt %)
B=amount of polyether polyol used in polymerization reaction (g)
C=amount of C₂-C₆ diol used in depolymerization reaction and/or esterification reaction (g).

The amount (unit: mol %) of the polyether polyol in the C₂-C₆ diol and the polyether polyol shown in Tables 1 to 4 below was calculated using the following Equation (2):

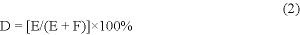

where D=amount of polyether polyol in C₂-C₆ diol and polyether polyol (mol %)
E=amount of polyether polyol used in polymerization reaction (mole)
F=amount of C₂-C₆ diol used in depolymerization reaction and/or esterification reaction (mole).

The amount (unit: wt %) of the polyether polyol in the reactant composition, based on the total weight of the polyol component and the reactant composition (i.e., the C₂-C₆ diol, the polyether polyol, and the PET-based recycled resin particle which were used in the depolymerization reaction, the esterification reaction, or/and the polymerization reaction) shown in Tables 1 to 4 below was calculated using the following Equation (3):

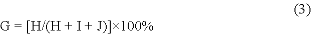

where G=amount of polyether polyol in reactant composition (wt %)
H=amount of polyether polyol used in polymerization reaction (g)
I=amount of C₂-C₆ diol used in depolymerization reaction and/or esterification reaction (g)
J=amount of PET-based recycled resin particle used in depolymerization reaction (g)

TABLE 1

| | | EX1 | EX2 | EX3 | EX4 |
|---|---|---|---|---|---|
| Depolymerization | PET-based recycled | 192 g | 192 g | 192 g | 192 g |
| reaction | resin particles | (1 mol) | (1 mol) | (1 mol) | (1 mol) |
| | 1,4-butanediol | 89 g | 54 g | 11 g | 0 |
| | | (0.99 mol) | (0.6 mol) | (0.12 mol) | |
| | 1,6-hexanediol | 24 g | 70 g | 71 g | 85 g |
| | | (0.2 mol) | (0.6 mol) | (0.6 mol) | (0.72 mol) |
| | 1,3-propanediol | 0 | 0 | 37 g | 37 g |
| | | | | (0.48 mol) | (0.48 mol) |
| | Ethylene glycol | 0 | 0 | 0 | 0 |
| | Neopentyl glycol | 0 | 0 | 0 | 0 |
| | Adipic acid | 0 | 0 | 0 | 0 |
| | DMI | 0 | 0 | 0 | 0 |
| | TPT (g) | 0.37 | 0.36 | 0.37 | 0.40 |
| | Temperature (° C.) | 240 | 240 | 240 | 240 |
| | Time period (hour) | 4 | 4 | 4 | 4 |
| Polymerization | PEG (M_{w}: 1000 | 74 g | 28 g | 0 | 64 g |
| reaction | g/mol) | (0.074 mol) | (0.029 mol) | | (0.064 mol) |
| | Copolymer of | 0 | 28 g | 0 | 0 |
| | ethylene oxide and | | (0.028 mol) | | |
| | propylene epoxide | | | | |
| | (M_{w}: 960 g/mol, | | | | |
| | amount of ethylene | | | | |
| | oxide: 28 wt %) | | | | |
| | PTMEG (M_{w}: 1000 | 0 | 0 | 74 g | 0 |
| | g/mol) | | | (0.074 mol) | |
| | PO3G (M_{w}: 1000 | 0 | 0 | 0 | 28 g |
| | g/mol) | | | | (0.028 mol) |
| | TPT (g) | 0.63 | 0.62 | 0.64 | 0.68 |
| | Irganox ® 1098 (g) | 0.32 | 0.31 | 0.32 | 0.34 |
| | Revonox ®608 (g) | 0.48 | 0.47 | 0.48 | 0.52 |
| | Temperature (° C.) | 250 | 250 | 250 | 250 |
| | Pressure (torr) | 1 | 1 | 1 | 1 |
| | Time period (hour) | 4 | 4 | 4 | 4 |
| Depolymerization | A: amount of | 39.6 | 31.1 | 38.3 | 43.0 |
| reaction or/and | polyether polyol in | | | | |
| polymerization | C₂-C₆ diol and | | | | |
| reaction | polyether polyol | | | | |
| | (wt %) | | | | |
| | D: amount of | 5.8 | 4.6 | 5.8 | 7.1 |
| | polyether polyol in | | | | |
| | C₂-C₆ diol and | | | | |
| | polyether polyol | | | | |
| | (mol %) | | | | |
| | G: amount of | 19.5 | 15.1 | 19.2 | 22.7 |
| | polyether polyol in | | | | |
| | reactant | | | | |
| | composition (wt %) | | | | |
| Regenerated | Melting point (° C.) | 124.1 | 107.4 | 85.0 | 98.3 |
| copolyester | Enthalpy (J/g) | 12.5 | 26.4 | 15.2 | 17.2 |
| | Glass transition | −16.6 | −26.0 | −17.9 | −55.4 |
| | temperature (° C.) | | | | |
| | Weight (g) | 301 | 291 | 304 | 325 |
| | K: amount of | 55.2 | 57.1 | 54.6 | 51.1 |
| | terephthalic acid | | | | |
| | derived from | | | | |
| | recycled polyester | | | | |
| | (wt %) | | | | |
| | Amount of first | 97 | 97 | 97 | 97 |
| | carboxylic acid | | | | |
| | ester segment | | | | |
| | (mol %) | | | | |
| | Amount of second | 3 | 3 | 3 | 3 |
| | carboxylic acid | | | | |
| | ester segment | | | | |
| | (mol %) | | | | |
| | Amount of third | 0 | 0 | 0 | 0 |
| | carboxylic acid | | | | |
| | ester segment | | | | |
| | (mol %) | | | | |

TABLE 2

| | | EX5 | EX6 | EX7 |
|---|---|---|---|---|
| Depolymerization | PET-based recycled resin | 173 g | 192 g | 135 g |
| reaction | particles | (0.9 mol) | (1 mol) | (0.7 mol) |
| | 1,4-butanediol | 0 | 54 g | 0 |
| | | | (0.6 mol) | |
| | 1,6-hexanediol | 50 g | 70 g | 170 g |
| | | (0.42 mol) | (0.6 mol) | (1.44 mol) |
| | 1,3-propanediol | 0 | 0 | 0 |
| | Ethylene glycol | 45 g | 0 | 22 g |
| | | (0.72 mol) | | (0.36 mol) |
| | Neopentyl glycol | 6 g | 0 | 0 |
| | | (0.06 mol) | | |
| | Adipic acid | 15 g | 0 | 0 |
| | | (0.1 mol) | | |
| | DMI | 0 | 0 | 50 g |
| | | | | (0.3 mol) |
| | TPT (g) | 0.27 | 0.36 | 0.43 |
| | Temperature (° C.) | 240 | 240 | 240 |
| | Time period (hour) | 4 | 4 | 4 |
| Polymerization | PEG (M_{w}: 1000 g/mol) | 0 | 0 | 0 |
| reaction | Copolymer of ethylene | 0 | 0 | 0 |
| | oxide and propylene | | | |
| | epoxide (M_{w}: 960 g/mol, | | | |
| | amount of ethylene oxide: | | | |
| | 28 wt %) | | | |
| | PTMEG (M_{w}: 1000 g/mol) | 0 | 74 g | 0 |
| | | | (0.074 mol) | |
| | PO3G (M_{w}: 1000 g/mol) | 0 | 0 | 0 |
| | TPT (g) | 0.46 | 0.64 | 0.66 |
| | Irganox ® 1098 (g) | 0.23 | 0.32 | 0.33 |
| | Revonox ®608 (g) | 0.35 | 0.48 | 0.50 |
| | Temperature (° C.) | 250 | 250 | 250 |
| | Pressure (torr) | 1 | 1 | 1 |
| | Time period (hour) | 4 | 4 | 4 |
| Depolymerization | A: amount of polyether | 0 | 37.4 | 0 |
| reaction or/and | polyol in C₂-C₆ diol and | | | |
| polymerization | polyether polyol (wt %) | | | |
| reaction | D: amount of polyether | 0 | 5.8 | 0 |
| | polyol in C₂-C₆ diol and | | | |
| | polyether polyol (mol %) | | | |
| | G: amount of polyether | 0 | 19.0 | 0 |
| | polyol in reactant | | | |
| | composition (wt %) | | | |
| Regenerated | Melting point (° C.) | 90.8 | 88.4 | 101.4 |
| copolyester | Enthalpy (J/g) | 24.5 | 17.2 | 5.9 |
| | Glass transition | 4.5 | −17.0 | 6.5 |
| | temperature (° C.) | | | |
| | Weight (g) | 202 | 304 | 200 |
| | K: amount of terephthalic | 74.0 | 54.6 | 58.1 |
| | acid derived from | | | |
| | recycled polyester (wt %) | | | |
| | Amount of first carboxylic | 87 | 100 | 67.9 |
| | acid ester segment | | | |
| | (mol %) | | | |
| | Amount of second | 3 | 0 | 32.1 |
| | carboxylic acid ester | | | |
| | segment (mol %) | | | |
| | Amount of third carboxylic | 10 | 0 | 0 |
| | acid ester segment | | | |
| | (mol %) | | | |

TABLE 3

| | | CE1 | CE2 | CE3 |
|---|---|---|---|---|
| Depolymerization | PET-based recycled resin | Not | 192 g | 192 g |
| reaction | particles | carried | (1 mol) | (1 mol) |
| | 1,4-butanediol | out | 86 g | 64 g |
| | | | (0.96 mol) | (0.72 mol) |
| | 1,6-hexanediol | | 28 g | 56 g |
| | | | (0.24 mol) | (0.48 mol) |
| | 1,3-propanediol | | 0 | 0 |
| | Ethylene glycol | | 0 | 0 |
| | Neopentyl glycol | | 0 | 0 |
| | Adipic acid | | 0 | 0 |
| | DMT | | 0 | 0 |
| | DMI | | 0 | 0 |
| | TPT (g) | | 0.37 | 0.29 |
| | Temperature (° C.) | | 240 | 240 |
| | Time period (hour) | | 4 | 4 |
| Esterification | 1,4-butanediol | 89 g | Not | Not |
| reaction | | (0.99 mol) | carried | carried |
| | 1,6-hexanediol | 24 g | out | out |
| | | (0.2 mol) | | |
| | 1,3-propanediol | 0 | | |
| | Ethylene glycol | 0 | | |
| | Neopentyl glycol | 0 | | |
| | Adipic acid | 0 | | |
| | DMT | 188 g | | |
| | | (0.97 mol) | | |
| | DMI | 4 g | | |
| | | (0.03 mol) | | |
| | TPT (g) | 0.37 | | |
| | Temperature (° C.) | 240 | | |
| | Time period (hour) | 4 | | |
| Polymerization | PEG (M_{w}: 1000 g/mol) | 74 g | 0 | 0 |
| reaction | | (0.074 mol) | | |
| | Copolymer of ethylene | 0 | 0 | 0 |
| | oxide and propylene | | | |
| | epoxide (M_{w}: 960 g/mol, | | | |
| | amount of ethylene oxide: | | | |
| | 28 wt %) | | | |
| | PTMEG (M_{w}: 1000 g/mol) | 0 | 74 g | 0 |
| | | | (0.074 mol) | |
| | PO3G (M_{w}: 1000 g/mol) | 0 | 0 | 0 |
| | TPT (g) | 0.63 | 0.63 | 0.50 |
| | Irganox ® 1098 (g) | 0.32 | 0.32 | 0.25 |
| | Revonox ®608 (g) | 0.48 | 0.48 | 0.38 |
| | Temperature (° C.) | 250 | 250 | 250 |
| | Pressure (torr) | 1 | 1 | 1 |
| | Time period (hour) | 4 | 4 | 4 |
| Depolymerization | A: amount of polyether | 39.6 | 39.4 | 0 |
| reaction, | polyol in C₂-C₆ diol and | | | |
| esterification | polyether polyol (wt %) | | | |
| reaction, or/and | D: amount of polyether | 5.8 | 5.8 | 0 |
| polymerization | polyol in C₂-C₆ diol and | | | |
| reaction | polyether polyol (mol %) | | | |
| | G: amount of polyether | 39.6 | 19.5 | 0 |
| | polyol in reactant | | | |
| | composition (wt %) | | | |
| Copolyester or | Melting point (° C.) | 132.4 | 115.8 | 112.2 |
| regenerated | Enthalpy (J/g) | 21.6 | 4.1 | 19.1 |
| copolyester | Glass transition | −18.2 | −7.2 | 18.4 |
| | temperature (° C.) | | | |
| | Weight (g) | 301 | 302 | 233 |
| | K: amount of terephthalic | 0 | 55.1 | 71.3 |
| | acid derived from | | | |
| | recycled polyester (wt %) | | | |
| | Amount of first carboxylic | 97 | 97 | 97 |
| | acid ester segment | | | |
| | (mol %) | | | |
| | Amount of second | 3 | 3 | 3 |
| | carboxylic acid ester | | | |
| | segment (mol %) | | | |
| | Amount of third carboxylic | 0 | 0 | 0 |
| | acid ester segment | | | |
| | (mol %) | | | |

TABLE 4

| | | CE4 | CE5 | CE6 |
|---|---|---|---|---|
| Depolymerization | PET-based recycled | 173 g | 173 g | 192 g |
| reaction | resin particles | (0.9 mol) | (0.9 mol) | (1 mol) |
| | 1,4-butanediol | 0 | 0 | 43 g |
| | | | | (0.48 mol) |
| | 1,6-hexanediol | 0 | 50 g | 85 g |
| | | | (0.42 mol) | (0.72 mol) |
| | 1,3-propanediol | 0 | 0 | 0 |
| | Ethylene glycol | 0 | 45 g | 0 |
| | | | (0.72 mol) | |
| | Neopentyl glycol | 0 | 6 g | 0 |
| | | | (0.06 mol) | |
| | Adipic acid | 0 | 0 | 0 |
| | DMT | 0 | 0 | 0 |
| | DMI | 0 | 0 | 0 |
| | TPT (g) | 0 | 0.27 | 0.47 |
| | Temperature (° C.) | 240 | 240 | 240 |
| | Time period (hour) | 4 | 4 | 4 |
| Esterification | 1,4-butanediol | 0 | 0 | Not carried |
| reaction | 1,6-hexanediol | 50 g | 0 | out |
| | | (0.42 mol) | | |
| | 1,3-propanediol | 0 | 0 | |
| | Ethylene glycol | 45 g | 0 | |
| | | (0.72 mol) | | |
| | Neopentyl glycol | 6 g | 0 | |
| | | (0.06 mol) | | |
| | Adipic acid | 15 g | 15 g | |
| | | (0.1 mol) | (0.1 mol) | |
| | DMT | 0 | 0 | |
| | DMI | 0 | 0 | |
| | TPT (g) | 0.27 | 0 | |
| | Temperature (° C.) | 240 | 240 | |
| | Time period (hour) | 1 | 1 | |
| Polymerization | PEG (M_{w}: 1000 g/mol) | 0 | 0 | 75 g |
| reaction | | | | (0.075 mol) |
| | Copolymer of ethylene | 0 | 0 | 75 g |
| | oxide and propylene | | | (0.078 mol) |
| | epoxide (M_{w}: 960 g/mol, | | | |
| | amount of ethylene | | | |
| | oxide: 28 wt %) | | | |
| | PTMEG (M_{w}: 1000 | 0 | 0 | 0 |
| | g/mol) | | | |
| | PO3G (M_{w}: 1000 g/mol) | 0 | 0 | 0 |
| | TPT (g) | 0.46 | 0.46 | 0.81 |
| | Irganox ® 1098 (g) | 0.23 | 0.23 | 0.41 |
| | Revonox ®608 (g) | 0.35 | 0.35 | 0.61 |
| | Temperature (° C.) | 250 | 250 | 250 |
| | Pressure (torr) | 1 | 1 | 1 |
| | Time period (hour) | 4 | 4 | 4 |
| Depolymerization | A: amount of polyether | 0 | 0 | 54.0 |
| reaction, | polyol in C₂-C₆ diol and | | | |
| esterification | polyether polyol (wt %) | | | |
| reaction, or/and | D: amount of polyether | 0 | 0 | 11.1 |
| polymerization | polyol in C₂-C₆ diol and | | | |
| reaction | polyether polyol (mol %) | | | |
| | G: amount of polyether | 0 | 0 | 31.9 |
| | polyol in reactant | | | |
| | composition (wt %) | | | |
| Regenerated | Melting point (° C.) | 103.5 | 102.1 | 107.5 |
| copolyester | Enthalpy (J/g) | 33.5 | 33.1 | 13.9 |
| | Glass transition | 3.2 | 3.4 | −62.2 |
| | temperature (° C.) | | | |
| | Weight (g) | 202 | 202 | 389 |
| | K: amount of | 74.0 | 74.0 | 42.7 |
| | terephthalic acid derived | | | |
| | from recycled polyester | | | |
| | (wt %) | | | |
| | Amount of first | 87 | 87 | 97 |
| | carboxylic acid ester | | | |
| | segment (mol %) | | | |
| | Amount of second | 3 | 3 | 3 |
| | carboxylic acid ester | | | |
| | segment (mol %) | | | |
| | Amount of third | 10 | 10 | 0 |
| | carboxylic acid ester | | | |
| | segment (mol %) | | | |

### Property Evaluation

### A. Determination of Melting Point, Enthalpy and Glass Transition Temperature (Tg)

The regenerated copolyester of a respective one of EX1 to EX7 and CE2 to CE6 or the copolyester of CE1 was subjected to determination of melting point, enthalpy, and glass transition temperature (Tg) using a differential scanning calorimeter (Manufacturer: TA Instruments, Model no.: Q2000), with parameters set to a heating rate of 10° C./min and a temperature increase from −100° C. to 250° C. The results are shown in Tables 1 to 4 above.

B. Calculation of Amount of Terephthalic Acid Derived from Recycled Polyester in Regenerated Copolyester

The amount of the terephthalic acid derived from the recycled polyester in the regenerated copolyester of the respective one of EX1 to EX7 and CE2 to CE6 was calculated using the following Equation (4):

$$K = \{ [ L \times ( M / N ) ] / P \} \times 100 \% \qquad ( 4 )$$

where K=amount of terephthalic acid derived from recycled polyester (wt %)
L=weight of PET-based recycled resin particles (g)
M=molecular weight of terephthalic acid (i.e., 166.1 g/mol)
N=molecular weight of repeat unit of PET (i.e., 192.2 g/mol)
P=weight of recycled polyester (g)

The results are shown in Tables 1 to 4 above.

### C. Determination of Peel Strength Before Washing

For the composite laminated body of the respective one of EX1 to EX7 and CE1 to CE6, the peel strength between the thermoplastic adhesive film and the polyester element (i.e., TE1331SR, TE1223R, or TE1142SR) before washing was determined using standard test method for peel resistance of adhesives (T-Peel Test) in accordance with the procedures set forth in ASTM D1876—08 (published in 2015). The results are shown in Tables 5 to 8 below.

D. Determination of Peel Strength after Washing

First, in accordance with the procedures set forth in AATCC 135 (published in 2018), the composite laminated body of the respective one of EX1 to EX7 and CE1 to CE6 was subjected to a washing treatment by immersing in water at a temperature of 45° C., followed by removing the composite laminated body from the water, and then placing the composite laminated body into an oven set at a temperature of 60° C. for a time period of 30 minutes for a drying treatment.

Subsequently, the aforesaid washing and drying treatments were repeated in sequence for a total of 9 times. Next, for the treated composite laminated body of the respective one of EX1 to EX7 and CE1 to CE6, the peel strength between the thermoplastic adhesive film and the polyester element (i.e., TE1331SR, TE1223R, or TE1142SR) after washing was determined using standard test method for peel resistance of adhesives (T-Peel Test) in accordance with the procedures set forth in ASTM D1876—08 (published in 2015).

The peel strength retention rate of the composite laminated body of the respective one of EX1 to EX7 and CE1 to CE6 was calculated using the following Equation (5):

$$Q = \{ 1 - [ ( R - S ) / R ] \} \times 100 \% \qquad ( 5 )$$

where Q=peel strength retention rate (%)
R=peel strength before washing (kgf)
S=peel strength after washing (kgf)

The results are shown in Tables 5 to 8 below.

### E. Determination of Resistance to Hydrostatic Pressure

First, a polyester element (i.e., TE1331SR, TE1223R, or TE1142SR) was cut into two pieces, followed by subjecting the two pieces to a sewing treatment, so as to obtain a stitched sheet. Then, the hot melt adhesive layer of the thermoplastic adhesive film of the respective one of EX1 to EX7 and CE1 to CE6 was disposed on a seam of the stitched sheet, followed by conducting a hot pressing treatment using a hot press machine at a temperature of 150° C. and a pressure of 2 kgf to allow the seam of the stitched sheet to be covered by the thermoplastic adhesive film, thereby obtaining a test sample.

Next, in accordance with the procedures set forth in AATCC 135 (published in 2018), the test sample of the respective one of EX1 to EX7 and CE1 to CE6 was immersed in water at a temperature of 45° C. for a washing treatment, followed by removing the test sample from the water, and then placing the test sample into an oven set at a temperature of 60° C. for a time period of 30 minutes for a drying treatment. Subsequently, the aforesaid washing and drying treatments were repeated in sequence for a total of 9 times. Afterwards, for the treated test sample of the respective one of EX1 to EX7 and CE1 to CE6, the resistance to hydrostatic pressure was determined by a hydrostatic pressure test in accordance with the procedures set forth in JIS L1092 (published in 2012). The results are shown in Tables 5 to 8 below.

### Results

TABLE 5

| | | | EX1 | EX2 | EX3 | EX4 |
|---|---|---|---|---|---|---|
| Between hot | Peel strength | TE1331SR | 1.14 | 1.13 | 1.07 | 1.10 |
| melt adhesive | before washing | TE1223R | 1.14 | 1.09 | 1.08 | 1.09 |
| layer and | (kgf) | TE1142SR | 1.12 | 1.12 | 1.11 | 1.10 |
| polyester | Peel strength | TE1331SR | 1.04 | 0.99 | 1.03 | 1.06 |
| element | after washing | TE1223R | 1.09 | 1.04 | 1.01 | 1.04 |
| | (kgf) | TE1142SR | 1.02 | 1.03 | 1.0 | 1.01 |
| | Peel strength | TE1331SR | 91.23 | 87.61 | 96.26 | 96.36 |
| | retention | TE1223R | 95.61 | 95.41 | 93.52 | 95.41 |
| | rate (%) | TE1142SR | 91.07 | 91.96 | 90.09 | 91.82 |
| Treated test | Resistance | TE1331SR | 7000 | 6000 | 7000 | 5000 |
| sample | to hydrostatic | TE1223R | 6000 | 6000 | 6000 | 5000 |
| | pressure (mmH₂O) | TE1142SR | 7000 | 5000 | 4000 | 4000 |

TABLE 6

| | | | EX5 | EX6 | EX7 |
|---|---|---|---|---|---|
| Between | Peel strength | TE1331SR | 1.07 | 1.09 | 1.12 |
| hot melt | before | TE1223R | 1.10 | 1.08 | 1.06 |
| adhesive | washing (kgf) | TE1142SR | 1.09 | 1.10 | 1.08 |
| layer and | Peel strength | TE1331SR | 1.07 | 1.05 | 1.10 |
| polyester | after washing | TE1223R | 1.05 | 1.03 | 1.04 |
| element | (kgf) | TE1142SR | 1.07 | 1.06 | 1.05 |
| | Peel strength | TE1331SR | 100.00 | 96.33 | 98.21 |
| | retention rate | TE1223R | 95.45 | 95.37 | 98.11 |
| | (%) | TE1142SR | 98.17 | 96.36 | 97.22 |
| Treated | Resistance to | TE1331SR | 8000 | 7000 | 5000 |
| test | hydrostatic | TE1223R | 6000 | 6000 | 5000 |
| sample | pressure | TE1142SR | 6000 | 7000 | 4000 |
| | (mmH₂O) | | | | |

TABLE 7

| | | | CE1 | CE2 | CE3 |
|---|---|---|---|---|---|
| Between | Peel strength | TE1331SR | 0.91 | 0.93 | 0.27 |
| hot melt | before | TE1223R | 0.79 | 0.88 | 0.23 |
| adhesive | washing (kgf) | TE1142SR | 0.80 | 0.59 | 0.17 |
| layer and | Peel strength | TE1331SR | 0.41 | 0.37 | 0 |
| polyester | after washing | TE1223R | 0.19 | 0.31 | 0 |
| element | (kgf) | TE1142SR | 0.11 | 0.10 | 0 |
| | Peel strength | TE1331SR | 45.05 | 39.78 | 0 |
| | retention rate | TE1223R | 24.05 | 35.23 | 0 |
| | (%) | TE1142SR | 13.75 | 16.95 | 0 |
| Treated | Resistance to | TE1331SR | 2000 | 2000 | 1000 |
| test | hydrostatic | TE1223R | 1000 | 1000 | 1000 |
| sample | pressure | TE1142SR | 1000 | 1000 | 1000 |
| | (mmH₂O) | | | | |

TABLE 8

| | | | CE4 | CE5 | CE6 |
|---|---|---|---|---|---|
| Between | Peel strength | TE1331SR | 0.8 | 0.84 | 0.57 |
| hot melt | before | TE1223R | 0.72 | 0.69 | 0.64 |
| adhesive | washing (kgf) | TE1142SR | 0.54 | 0.57 | 0.77 |
| layer and | Peel strength | TE1331SR | 0.24 | 0.23 | 0.14 |
| polyester | after washing | TE1223R | 0.33 | 0.28 | 0.21 |
| element | (kgf) | TE1142SR | 0.17 | 0.17 | 0.2 |
| | Peel strength | TE1331SR | 30.00 | 27.38 | 24.56 |
| | retention rate | TE1223R | 45.83 | 40.58 | 32.81 |
| | (%) | TE1142SR | 31.48 | 29.82 | 25.97 |
| Treated | Resistance to | TE1331SR | 1000 | 1000 | 2000 |
| test | hydrostatic | TE1223R | 1000 | 1000 | 1000 |
| sample | pressure | TE1142SR | 1000 | 1000 | 1000 |
| | (mmH₂O) | | | | |

Referring to Tables 5 to 8, before and after washing, the peel strengths between the hot melt adhesive layer and the polyester element in the composite laminated body of a respective one of EX1 to EX7 were greater than those of a respective one of CE1 to CE6, indicating that the hot melt adhesive layer of the thermoplastic adhesive film of the respective one of EX1 to EX7, which was made from the regenerated copolyester, was able to securely bond to the polyester element, resulting in the composite laminated body of the respective one of EX1 to EX7 having excellent washability.

In addition, all of the peel strength retention rates of the composite laminated bodies of EX1 to EX7 were not lower than 80%, whereas all of the peel strength retention rates of the composite laminated bodies of CE1 to CE6 were not greater than 50%. These results demonstrate that the composite laminated body of the present disclosure (i.e., EX1 to EX7) retains a strong adhesive property after being subjected to the washing treatment at the temperature of 45° C. and the drying treatment at the temperature of 60° C. for 30 minutes repeated in sequence for a total of 10 times.

Referring to Tables 5 to 8 again, the resistance to hydrostatic pressure of the treated test sample of the respective one of EX1 to EX7 was greater than that of the respective one of CE1 to CE6. These results indicate that by virtue of the seam of the stitched sheet being covered by the thermoplastic adhesive film of the present disclosure (i.e., EX1 to EX7), the treated test sample can maintain waterproof functionality at seam junctions.

Referring to Table 3, the copolyester of CE1 was made from petroleum-based monomers, rather than from monomers formed through the depolymerization reaction of the recycled polyester, so that the chain segment of the copolyester of CE1 had a relatively regular structure. Therefore, referring to Table 1 in conjunction with Table 3, the melting point and enthalpy of the copolyester of CE1 showed a substantial increase compared with those of the regenerated copolyester of EX1. In addition, the melting point of the copolyester of CE1 was greater than 130° C., leading to the composite laminated body of CE1 having a poor adhesive property and decrease in the peel strength between the hot melt adhesive layer and the polyester element before and after washing.

Referring to Table 3 again, the enthalpy of the regenerated copolyester of CE2 was lower than 5 J/g, indicating that the regenerated copolyester of CE2 had insufficient crystallinity and the thus inadequate mechanical strength, leading to the composite laminated body of CE2 having a poor adhesive property and decrease in the peel strengths between the hot melt adhesive layer and the polyester element before and after washing, thereby adversely affecting the resistance to hydrostatic pressure of the treated test sample of CE2.

Referring back to Table 3, the glass transition temperature (Tg) of the regenerated copolyester of CE3 was greater than 10° C., indicating that the molecular chain of the regenerated copolyester of CE3 had limited mobility, so that the hot melt adhesive layer containing the regenerated copolyester of CE3 could not adhere well to the polyester element, leading to the composite laminated body of CE3 having a poor adhesive property and decrease in the peel strengths between the hot melt adhesive layer and the polyester element before and after washing, thereby adversely affecting the resistance to hydrostatic pressure of the treated test sample of CE3.

Referring to Table 4, by virtue of the procedure for preparing the regenerated copolyester including the esterification reaction, regardless of whether such esterification reaction took place before (i.e., CE4) or after (i.e., CE5) the depolymerization reaction, the chain segment of the regenerated copolyester of a respective one of CE4 and CE5 had a relatively regular structure. Therefore, referring to Table 2 in conjunction with Table 4, the melting point and enthalpy of the regenerated copolyester of the respective one of CE4 and CE5 showed a substantial increase compared with those of the regenerated copolyester of EX5. In addition, the enthalpy of the regenerated copolyester of the respective one of CE4 and CE5 was greater than 30 J/g, leading to the composite laminated body of the respective one of CE4 and CE5 having a poor adhesive property and decrease in the peel strengths between the hot melt adhesive layer and the polyester element before and after washing, thereby adversely affecting the resistance to hydrostatic pressure of the treated test sample of the respective one of CE4 and CE5.

Referring to Table 4 in conjunction with Table 8, the glass transition temperature (Tg) of the regenerated copolyester of CE6 was lower than −60° C., indicating that the molecular chain of the regenerated copolyester of CE6 had excessive mobility and the hot melt adhesive layer containing the regenerated copolyester of CE6 was prone to swelling after immersion in water, leading to the composite laminated body of CE6 having a decrease in the peel strength between the hot melt adhesive layer and the polyester element after washing, thereby adversely affecting the resistance to hydrostatic pressure of the treated test sample of CE6.

Summarizing the above test results, it is clear that by virtue of optimizing the melting point, glass transition temperature (Tg), and enthalpy of the regenerated copolyester, the thermoplastic adhesive film of the present disclosure containing the polyester layer and the hot melt adhesive layer that includes the regenerated copolyester can be effectively applied to seam junctions between elements (e.g., moisture-permeable waterproof membranes or polyester elements) in products such as fabrics or footwear. Therefore, even after the products are subjected to at least one washing treatment, the hot melt adhesive layer of the thermoplastic adhesive film of the present disclosure remains securely bonded to the elements, resulting in excellent washability of the products and maintenance of a strong adhesive property of the thermoplastic adhesive film after undergoing a washing treatment at the temperature of 45° C. and a drying treatment at the temperature of 60° C., thereby maintaining a waterproof functionality at the seam junctions in the products. Furthermore, an essential material of the thermoplastic adhesive film of the present disclosure is a polyester and the thermoplastic adhesive film is free from a urethane group, which allow the aforesaid products to be easily processed for recycling, and thus the thermoplastic adhesive film can be efficiently removed and separated from the products, thereby achieving sustainable environmental goals of waste reduction and plastics reduction.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, the one or more features may be singled out and practiced alone without the another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A thermoplastic adhesive film, comprising:
a polyester layer having a moisture permeability of not greater than 5000 g/m²·24 h; and
a hot melt adhesive layer disposed on the polyester layer and including a regenerated copolyester;
the thermoplastic adhesive film being free from a urethane group;
wherein the regenerated copolyester is formed by subjecting a reactant composition containing a depolymerized component to a polymerization reaction, the depolymerized component being selected from the group consisting of a depolymer with a main chain containing a terephthalic acid ester group, a depolymer with a main chain containing a terephthalic acid ester group and an isophthalic acid ester group, a depolymer with a main chain containing a terephthalic acid ester group and a bivalent C₁-C₄ straight chain dicarboxyl ester group, a depolymer with a main chain containing a terephthalic acid ester group, an isophthalic acid ester group, and a bivalent C₁-C₄ straight chain dicarboxyl ester group, a depolymer with a main chain containing an isophthalic acid ester group, a depolymer with a main chain containing a bivalent C₁-C₄ straight chain dicarboxyl ester group, a depolymer with a main chain containing an isophthalic acid ester group and a bivalent C₁-C₄ straight chain dicarboxyl ester group, and combinations thereof;
wherein the depolymerized component is obtained by subjecting a recycled polyester to a depolymerization reaction in the presence of a depolymerizing agent, the depolymerizing agent being selected from the group consisting of a polyol component, a polycarboxylic acid component, and a combination thereof, the recycled polyester being selected from the group consisting of a recycled polyester with a main chain containing a terephthalic acid ester group, a recycled polyester with a main chain containing a terephthalic acid ester group and an isophthalic acid ester group, and a recycled polyester with a main chain containing a terephthalic acid ester group and a bivalent C₁-C₄ straight chain dicarboxyl ester group;
wherein the regenerated copolyester has terephthalic acid derived from the recycled polyester in an amount of not lower than 20 wt %;
wherein the regenerated copolyester has a melting point ranging from 80° C. to 130° C., a glass transition temperature (Tg) ranging from −60° C. to 10° C., and an enthalpy ranging from 5 J/g to 30 J/g; and
wherein the regenerated copolyester includes a first carboxylic acid ester segment that is present in an amount ranging from 50 mol % to 100 mol % and represented by formula (I), a second carboxylic acid ester segment that is present in an amount ranging from 0 mol % to 35 mol % and represented by formula (II), and a third carboxylic acid ester segment that is present in an amount ranging from 0 mol % to 15 mol % and represented by formula (III), based on a total amount of the regenerated copolyester as 100 mol %, 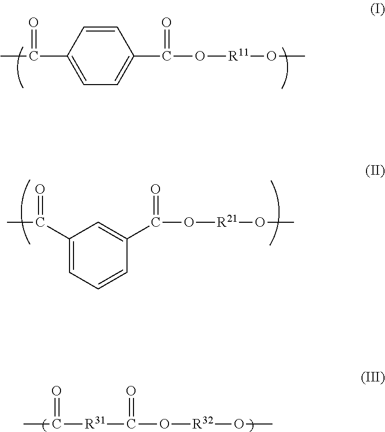
where
in formula (I), R¹¹ is a bivalent C₂-C₆ alkyl group or an alkyl ether group with a number average molecular weight ranging from 450 g/mol to 1000 g/mol, in formula (II), R²¹ is a bivalent C₂-C₆ alkyl group or an alkyl ether group with a number average molecular weight ranging from 450 g/mol to 1000 g/mol, and
in formula (III), R³¹ is a bivalent C₁-C₄ straight chain alkyl group, and R³² is a bivalent C₂-C₆ alkyl group or an alkyl ether group with a number average molecular weight ranging from 450 g/mol to 1000 g/mol.

2. The thermoplastic adhesive film as claimed in claim 1, wherein the depolymerizing agent is the polyol component.

3. The thermoplastic adhesive film as claimed 2, wherein the polyol component is a biomass polyol component.

4. The thermoplastic adhesive film as claimed in claim 1, wherein the polyester layer has the moisture permeability of not greater than 1600 g/m²·24 h.

5. The thermoplastic adhesive film as claimed in claim 2, wherein the polyol component includes at least two polyols selected from the group consisting of a C₂-C₆ diol and a polyether polyol with a number average molecular weight ranging from 450 g/mol to 1000 g/mol.

6. The thermoplastic adhesive film as claimed in claim 5, wherein the polyol component includes the at least two polyols which are C₂-C₆ diols.

7. The thermoplastic adhesive film as claimed in claim 6, wherein the reactant composition further includes a polyether polyol with a number average molecular weight ranging from 450 g/mol to 1000 g/mol.

8. The thermoplastic adhesive film as claimed in claim 5, wherein the C₂-C₆ diol is selected from the group consisting of ethylene glycol, propylene glycol, butylene glycol, pentylene glycol, 3-methyl-1,5-pentanediol, hexylene glycol, neopentyl glycol, and combinations thereof.

9. The thermoplastic adhesive film as claimed in claim 5, wherein the polyether polyol is selected from the group consisting of a copolymer of ethylene oxide and propylene epoxide, a copolymer of ethylene oxide and tetrahydrofuran, poly(ethylene glycol) (PEG), poly(propylene glycol), poly(tetramethylene ether)glycol (PTMEG), poly(hexylene glycol), poly(trimethylene ether)glycol (PO3G), decaethylene glycol, and combinations thereof.

10. The thermoplastic adhesive film as claimed in claim 7, wherein the polyether polyol is selected from the group consisting of a copolymer of ethylene oxide and propylene epoxide, a copolymer of ethylene oxide and tetrahydrofuran, poly(ethylene glycol) (PEG), poly(propylene glycol), poly(tetramethylene ether)glycol (PTMEG), poly(hexylene glycol), poly(trimethylene ether)glycol (PO3G), decaethylene glycol, and combinations thereof.

11. The thermoplastic adhesive film as claimed in claim 5, wherein one of the at least two polyols is hexylene glycol.

12. The thermoplastic adhesive film as claimed in claim 7, wherein the polyether polyol in the reactant composition is present in an amount ranging from 15 wt % to 23 wt %, based on the total weight of the polyol component and the reactant composition.

13. The thermoplastic adhesive film as claimed in claim 1, wherein the depolymerizing agent is the polycarboxylic acid component, the polycarboxylic acid component being present in an amount ranging from 0 mol % to 10 mol %, based on a total amount of the polycarboxylic acid component and the recycled polyester as 100 mol %.
